(19) United States
(12) Patent Application Publication
(10) Pub. No.: US 2022/0021784 A1
(43) Pub. Date: Jan. 20, 2022

(54) MARKING TECHNIQUE IDENTIFICATION

(71) Applicant: Hewlett-Packard Development Company, L.P., Spring, TX (US)

(72) Inventors: Amisha Ami Buch, Bangalore (IN); Bharani Nunna, Bangalore (IN); Manjunath Narayan, Bangalore (IN); Sandeep Matti Prabhu, Bangalore (IN)

(73) Assignee: Hewlett-Packard Development Company, L.P., Spring, TX (US)

(21) Appl. No.: 17/298,588

(22) PCT Filed: Dec. 5, 2019
(86) PCT No.: PCT/US2019/064575

§ 371 Date: May 30, 2021

(30) Foreign Application Priority Data
Feb. 4, 2019 (IN) IN201941004406

(51) Int. Cl. H04N 1/32; G06F 3/12; G06T 1/00

(52) U.S. Cl. CPC H04N 1/32352; G06F 3/1243; H04N 2201/327; G06T 1/0021; H04N 1/32331; G06F 3/1222

(57) ABSTRACT

The subject matter discloses examples of an identification marking system comprising a component analyzer to identify a plurality of components present within a print artwork. The identification marking system further comprises a marking technique analyzer to determine marking settings for the plurality of components based on component properties and predefined marking rules. The marking settings for a component indicates a marking technique identified for linking an identification mark with the component. The marking technique analyzer is further to communicate the print artwork and the marking settings to an identification marking engine for identification marking.

### BACKGROUND

Identification marks are machine-readable links that may be embedded within a print artwork to store information regarding authentication, source tracing and tracking, serialization, and other information related to either the print artwork or an article associated with the print artwork. Usually, identification marks, such as bar codes, and quick response (QR) codes may be embedded in the print artwork. Such identification marks may be scanned and read by an appropriate electronic device, such as scanners to obtain the embedded information.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates an identification marking system, according to an example implementation of the present subject matter.

FIG. 2 illustrates an identification marking environment, according to an example implementation of the present subject matter.

FIG. 3 illustrates an exemplary print artwork, according to another example implementation of the present subject matter.

FIG. 4 illustrates a method for marking technique identification, according to an example implementation of the present subject matter.

FIG. 5 illustrates a computer-implemented method for marking technique identification, according to an example implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Identification marks, such as a machine-readable media or a machine-readable link are used in a print work to embed information about either the print artwork or an object carrying the print artwork. Examples of applications using identification marks for storing information within a print artwork may include, but are not limited to, product packaging, shopping, inventory management, transportation, art replication, and providing support services. For instance, in packaging industries, identification marks may be used to carry product information, such as detailed pricing, content, nutritional information, serialization data, and manufacturing site ID. In service industries, identification marks may be used to provide support and troubleshooting information.

Usually, to insert an identification mark in a print artwork, graphic designers identify different components from within the print artwork for associating the identification marks. The graphic designers may further determine various marking techniques, such as watermarking, barcoding, and quick response (QR) coding that may be used to embed the identification marks within the components. The components and the marking techniques are identified such that the content and the quality of the print artwork is not affected when the identification mark is embedded within the components. The graphic designers typically analyze the print artwork manually, to determine the suitable components and the marking technique based on their knowledge and experience. Once the marking technique for different components is identified, the designers use an identification marking unit for marking the identified components with the identification mark.

However, manually identifying the marking techniques is a time-consuming process and often takes up weeks for preparing a single print artwork. Such a process may thus not be suited for commercial applications involving large number of print artworks. Further, manually determining the marking techniques for each print artwork would require a certain degree of skill and expertise and the correctness of the marking may thus depend on the skills and expertise of the graphic designer. For instance, if the graphic designer identifies an incorrect marking technique for a component, then either the component may become distorted owing to presence of the identification mark or the identification mark may not be in a readable form and may be hidden behind the component.

The present subject matter relates to marking technique identification for identification marking of a print artwork. In an example embodiment, an identification marking system is to analyze the print artwork and identify marking techniques that may be used for embedding identification marks within a print artwork. In said example, the identification marking system may initially identify a plurality of components within the print artwork. Once the plurality of components is identified, marking settings for each of the plurality of components is determined. The marking settings for a component may indicate the marking technique identified for linking an identification mark with the component. In one example, the marking settings for the plurality of components may be determined based on component properties and predefined marking rules. The present subject matter thus provides an automated system for marking technique identification, ensuring that the marking techniques are efficiently and reliably identified.

In operation, upon receiving a print artwork from a user, the print artwork is analyzed by the identification marking system to extract a set of markable media layers present within the print artwork. Subsequently, a plurality of components present within the set of markable layers are identified. The identification marking system further tags each component with a component type tag. Examples of the component type tag include, but are not limited to, an image, text, spot color, non-markable component, and no ink areas.

The identification marking system may further analyze each component to determine component properties, such as component size, location, color, and type of image. The identification marking system subsequently identifies the marking technique for each component based on the component type tag, the component properties, and the predefined marking rules. In one example, for each component, the identification marking system may initially determine a component sub type for the component based on the component properties and the component type tag. The identification marking system may subsequently determine the marking technique mapped with the component sub type based on the predefined marking rules. The identification marking system may then identify the determined marking technique as the marking technique for linking the identification mark with the component.

The identification marking system may then communicate the print artwork and the marking settings to an identification marking engine for linking a set of components, from the plurality of components, with the corresponding identification mark. The identification marking engine may then mark the different components within the print artwork using the marking technique indicated within the marking settings to generate a marked-up print artwork. The identification marking system may subsequently generate a print ready artwork having a plurality of copies of the marked-up print artwork.

The present subject matter thus provides a fast, efficient, and reliable system for identifying marking techniques for inserting an identification mark in a print artwork. Having a rule based automated system for marking technique identification facilitates in ensuring that the marking techniques are efficiently and reliably identified, owing to which the identification marks may be correctly embedded without distorting the print artwork. Further, removing the human dependency in identifying the marking technique helps in substantially reducing the time taken to identify the marking techniques and obtaining the print ready artwork having the identification marks. Thus, a large-scale marking of print artworks may be achieved without affecting the quality of the print artwork and the identification mark.

Further, each layer of the print artwork is extracted to identify a set of markable layers and individual components present in the markable layers are identified and analyzed for ascertaining the marking technique for the component. Thereby, it is ensured that for each component the best suitable marking technique is used. Thus, the identification marks do not overlap with components and the print artwork is not damaged. As a result, print artwork may be marked with high accuracy and efficiency. Thus, the present subject matter provides a cost efficient and reliable system for identifying marking techniques that may reduce the time required in identifying the marking technique and an overall time and cost involved in obtaining print ready artwork, such as packaging artworks.

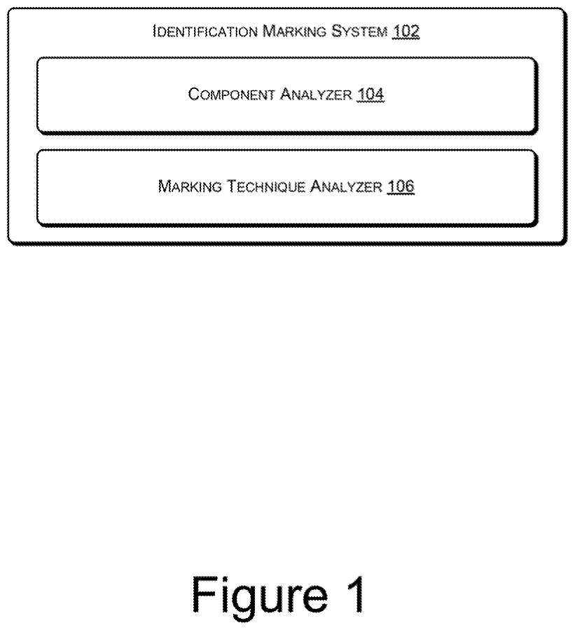

The present subject matter is further described with reference to FIGS. 1 to 5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates an identification marking system 102, according to an example implementation of the present subject matter. In one example, the identification marking system 102 may be implemented in a single computing system. In another example, the identification marking system 102 may be implemented in a distributed computing system. In one example, the identification marking system 102 may identify marking techniques for identification marking of a print artwork. Examples of the print artwork may include, but are not limited to, a packaging artwork, layout of a book, and an advertising banner. In one example, the print artwork may include various content, such as logos, graphics, background, and textual information.

In one implementation, the identification marking system 102 includes a component analyzer 104 to identify a plurality of components present within a print artwork. The identification marking system 102 further includes a marking technique analyzer 106 to determine marking settings of the plurality of components based on component properties and predefined marking rules. In one example, the marking settings for a component may indicate a marking technique identified for linking an identification mark with the component. Examples of marking techniques include, but are not limited to, quick response (QR) codes, Barcodes, and binary watermarks.

Upon determining the marking settings of the plurality of components, the marking technique analyzer 106 may communicate the print artwork and the marking settings to an identification marking engine for identification marking. In an example, the identification marking of the print artwork may include embedding identification marks with the components present in the print artwork using the identified marking techniques.

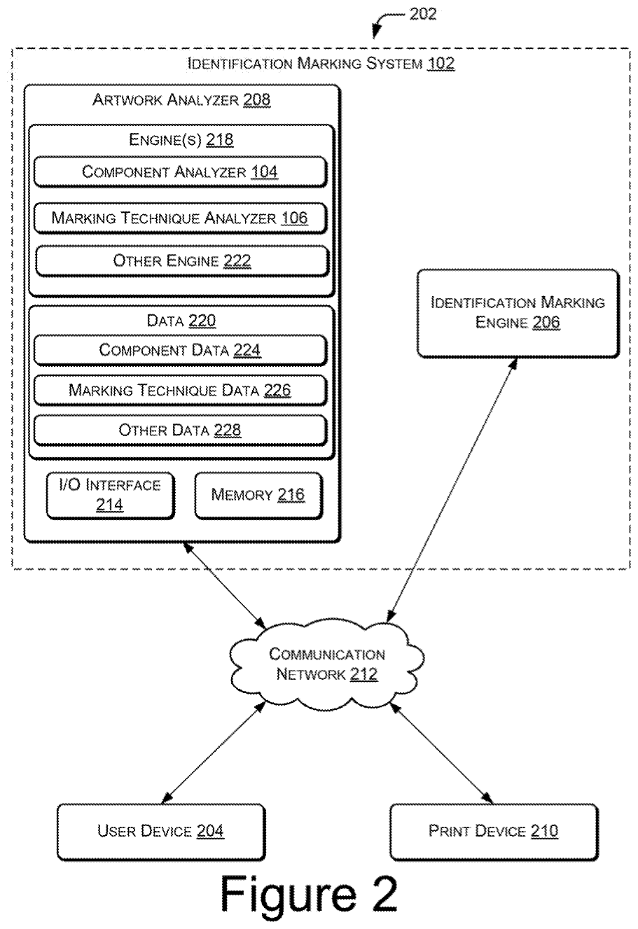

FIG. 2 illustrates an identification marking environment 202, according to an example implementation of the present subject matter. The identification marking environment 202 includes the identification marking system 102 for marking the print artwork provided by a user through a user device 204. In one example, the identification marking system 102 may include an identification marking engine 206 for marking various components of the print artwork with identification markings using marking techniques. The identification marking system 202 may further include an artwork analyzer 208 for identifying the marking techniques. The identification marking environment 202 may further include a print device 210 for printing a print ready print artwork, having the identification markings.

The user device 204, the print device 210, the identification marking engine 206, and the artwork analyzer 208 may be connected to each other over a communication network 212. Examples of the user device 204 include, but are not limited to, desktop computers, laptops, tablets, portable computers, workstation, mainframe computer, servers, and network servers. Examples of the print device 210 include, but are not limited to, printer, a multifunction printer, a home printer, and an office printer. Further, in one example, the identification marking system 102 may be implemented as a distributed computing system with the artwork analyzer 208 and the identification marking engine 206 may be implemented on individual electronic devices. The artwork analyzer 208 and the identification marking engine 206 may be implemented in the same geographical location or may be located in different geographical locations. Further, either of the artwork analyzer 208 and the identification marking engine 206 may be provided using cloud computing.

In another example, the identification marking system 102 may be implemented as a single computing system comprising the artwork analyzer 208 and the identification marking engine 206. Examples of the electronic devices implementing the artwork analyzer 208, the identification marking engine 206, and the identification marking system 102 include, but are not limited to, desktop computers, laptops, tablets, portable computers, workstation, mainframe computer, servers, distributed computing systems, and network servers.

The communication network 212 may be a wireless network, a wired network, or a combination thereof. The communication network 212 may also be an individual network or a collection of many such individual networks, interconnected with each other and functioning as a single large network, e.g., the Internet or an intranet. The communication network 212 may be one of the different types of networks, such as intranet, local area network (LAN), wide area network (WAN), and the internet. In an example, the communication network 212 may include any communication network that use any of the commonly used protocols, for example, Hypertext Transfer Protocol (HTTP), and Transmission Control Protocol/Internet Protocol (TCP/IP).

The artwork analyzer 208 includes I/O interface(s) 214 and memory 216. The I/O interface(s) 214 may include a variety of interfaces, for example, interfaces for data input and output devices, referred to as I/O devices, storage devices, network devices and the like. The I/O interface(s) 214 may facilitate communication between the artwork analyzer 208, identification marking engine 206, the user device 204, the print device 210, and various other computing devices connected in the identification marking environment 202. The I/O interface(s) 214 may also provide a communication pathway for one or more components of the artwork analyzer 208. Examples of such components include, but are not limited to, input device, such as keyboards and a touch enabled graphical user interface.

The memory 216 may store one or more computer-readable instructions, which may be fetched and executed to provide interfaces to users for providing print artwork. The memory 216 may include any non-transitory computer-readable medium including, for example, volatile memory such as RAM, or non-volatile memory such as EPROM, flash memory, and the like. The artwork analyzer 208 further includes engine(s) 218 and data 220.

The engine(s) 218 may be implemented as a combination of hardware and programming (for example, programmable instructions) to implement one or more functionalities of the engine(s) 218. In examples described herein, such combinations of hardware and programming may be implemented in several different ways. For example, the programming for the engine(s) 218 may be processor executable instructions stored on a non-transitory machine-readable storage medium and the hardware for the engine(s) 218 may include a processing resource (for example, one or more processors), to execute such instructions. In the present examples, the machine-readable storage medium may store instructions that, when executed by the processing resource, implement engine(s) 218. In such examples, the artwork analyzer 208 may include the machine-readable storage medium storing the instructions and the processing resource to execute the instructions, or the machine-readable storage medium may be separate but accessible to the artwork analyzer 208 and the processing resource. In other examples, engine(s) 218 may be implemented by electronic circuitry.

The data 220 includes data that is either stored or generated as a result of functionalities implemented by any of the engine(s) 218. The engine(s) 218 of the artwork analyzer 208 include the component analyzer 104, the marking technique analyzer 106, and other-engine(s) 222. The other engine(s) 222 may implement functionalities that supplement applications or functions performed by the engine(s) 218. Further, the data 220 may include component data 224, marking technique data 226, and other data 228.

In one example, a user, such as a creator or a user of the print artwork may provide the print artwork to the identification marking system 102 for obtaining a print ready artwork having identification marks. In an example, the user may transmit a print artwork marking request along with the print artwork to the artwork analyzer 208 using the user device 204. In one example, the user of the user device 210 may access a user interface or an API (Application programming interface) of the artwork analyzer 208 to provide the print artwork marking request along with the print artwork.

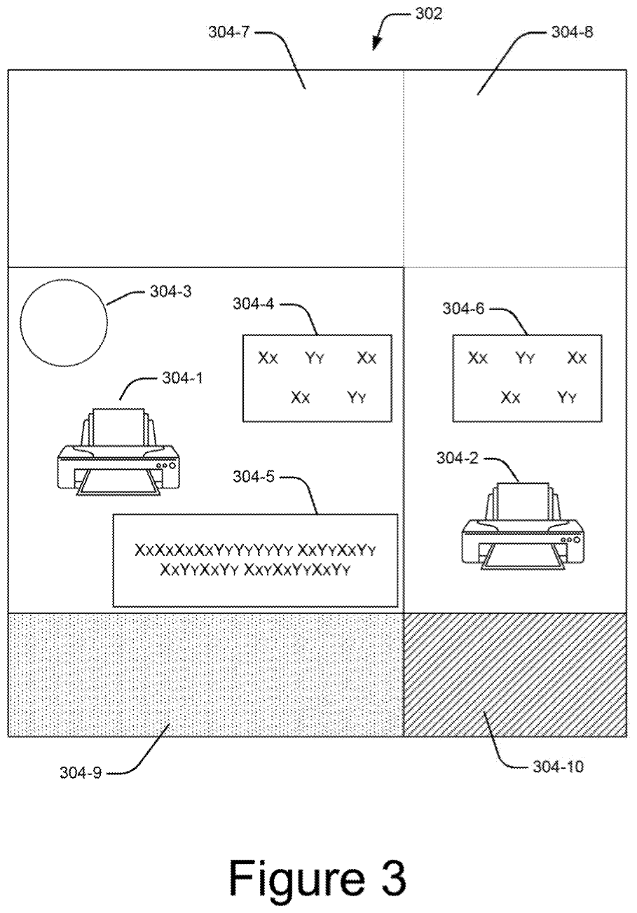

The further operation of the artwork analyzer 208 has been described in conjunction with an example print artwork 302 illustrated in the FIG. 3. FIG. 3 illustrates the example print artwork 302, according to another example implementation of the present subject matter.

Upon receiving the print artwork, the component analyzer 104 may analyze the print artwork 302 to extract a plurality of media layers from within the print artwork 302. In one example, the component analyzer 104 may use segmentation techniques for extraction of the media layers from the print artwork. In one example, the print artwork 302 may include the plurality of media layers layered one above the other. Thus, each of the plurality of media layers may have a defined hierarchy, also to referred as depth, with respect to other media layers. In one example, the hierarchy of a media layer may indicate a number of media layers present above the media layer.

Subsequently, the component analyzer 104 identifies a set of markable layers from among the plurality of media layers, based on the hierarchy of each of the plurality of media layers. In an example, a media layer may be identified as markable if the media layer is either at top of other layers or is present under a transparent layer. If the layer is present beneath an opaque layer, the media layer may be identified as non-markable. Thus, the component analyzer 104 may identify the media layers underneath an opaque media layer as non-markable layers and classify the remaining media layers as the set of markable layers.

Further, for each of the markable layers, the component analyzer 104 may identify components present in the markable layer. Examples of the components may include, but are not limited to, images, text regions, logos, and white/non-white space. In one example, the example print artwork 302 includes a plurality of components 304-1, 304-2, 304-3, 304-4, 304-5, 304-6, 304-7 and 304-8. The plurality of components 304-1, 304-2, 304-3, 304-4, 304-5, 304-6, 304-7, and 304-8 are hereinafter collectively referred to as components 304 and individually as component 304. In one example, the component analyzer 104 may use various techniques, such as image recognition, optical character recognition, and feature extraction techniques for identifying components present in the print artwork 302. The component analyzer 104 may further save details related to the plurality of components in the component data 224.

The component analyzer 104 may subsequently tag each of the plurality of components with a component type tag. In an example, the component type tag maybe selected from a group consisting of images, text, spot color, non-markable components, and no ink areas. The component type tag is indicative of the type of the component and may be used to identify suitable marking techniques that could be applied to a particular type of component.

For example, the component analyzer 104 may analyze the print artwork 300 to identify the various components 304 present in the print artwork 302. The component analyzer 104 may further associate the components 304 with component type tags. For instance, the component analyzer 104 may tag the components 304-1, 304-2, and 304-3 using the component type tag—image. Similarly, the component analyzer 104 may tag the component components 304-4. 304-5, 304-6 using the component type tag—text. Similarly, the component analyzer 104 may tag the components 304-7, 304-8, 304-9 using the component type tag—no ink areas, and the component analyzer 104 may tag the component 304-10 using the component type tag—spot color.

The component analyzer 104 further analyzes each of the component to determine component properties associated with the component. Examples of the component properties may include, but are not limited to, component size, location of component in the print artwork, color of component, and type of image. In an example, the component analyzer 104 may use pattern recognition techniques to determine the component properties.

For example, the component analyzer 104 may analyze the component 304-1 to identify the component properties like location as—top right, color as multicolored, and type of image as raster.

The marking technique analyzer 106 may subsequently determine marking settings for the plurality of components based on the component type tag, the component properties, and the predefined marking rules. In one example, the marking technique analyzer 106 may initially determine a component type for each of the plurality of components based on the component type tag. Examples of the component type include, but are not limited to, an image, a text area, spot color, and no ink areas.

For example, the marking technique analyzer 106 may analyze the component type tag associated with each of the components 304 to identify the component type. For instance, the marking technique analyzer 106 may use the component type tag associated with the components 304-1, 304-2, and 304-3 to determine the component type as image, indicating that the components 304-1, 304-2, and 304-3 are images. Similarly, the marking technique analyzer 106 may use the component type tag associated with the components 304-4, 304-5, and 304-6 to determine the component type as text, indicating that the components 304-4, 304-5, and 304-6 are text regions. Further, the marking technique analyzer 106 may use component type tag associated with the components 304-7, 304-8, 304-9 to determine the component type as no ink area, indicating that the components 304-7, 304-8, and 304-9 are no ink areas. Further, the marking technique analyzer 106 may use component type tag associated with the component 304-10 to determine the component type as spot color, indicating that the component 304-10 is a spot color.

Further, for each of the plurality of components 304, the marking technique analyzer 106 determines a component sub type based on the component properties and the component type. For example, the marking technique analyzer 106 may analyze the component type and the component properties associated with each of the components 304 to identify the components' component sub type. For instance, the marking technique analyzer 106 may use the component type and the component properties associated with the components 304-1, 304-2 to determine the component sub type as a raster image. Similarly, the marking technique analyzer 106 may analyze the component type and the component properties associated with the component 304-3 to determine the component sub type as a vector image, indicating that the component 304-3 is a vector image.

Similarly, the marking technique analyzer 106 may analyze the component type and component properties associated with the component 304-5 to determine the component sub type as dense text. Further, the marking technique analyzer 106 may analyze the component type and the component properties associated with the components 304-4 and 304-6 to determine the component sub type as sparse text. Similarly, the marking technique analyzer 106 may analyze the component type and the component properties associated with the components 304-7 and 304-8 to determine the component sub type as a white region. Further, the marking technique analyzer 106 may analyze the component type and the component properties associated with the component 304-9 to determine the component sub type as a black region. Similarly, the marking technique analyzer 106 may analyze the component type and the component properties associated with the components 304-10 to determine the component sub type as a colored region, indicating that the component 304-10 is a colored region filled with a color other than black and white.

Further, the marking technique analyzer 106 may determine a marking technique for the component sub type based on the predefined marking rules. Examples of marking techniques may include, but are not limited to, barcoding, quick response (QR) coding, binary watermarking, and digital image watermarking. In an example, binary watermarking technique involves placing a pattern of dots or binary patterns of certain size and color that merges with the background. Quick response (QR) coding is a technique that contains black squares arranged in a square grid on a white background. Data from a QR code may be extracted from pattern in both horizontal and vertical components of the code. Barcodes use a sequence of vertical bars and spaces that represent numbers and other symbols. Further, digital image watermarking uses different techniques to embed data in an image. Examples of digital image watermarking techniques include, but are not limited to, spread spectrum, quantization type and amplitude modulation.

In an example, each of the component may be associated with a single marking technique. In another example, each of the component may be associated with a different marking technique.

The predefined marking rules are set of instructions that may be used while determining the marking technique for each component sub type. In one example, the predefined marking rules may be provided as a mapping between the component sub types and marking technique. Further, multiple marking techniques may be associated with a component sub type and the predefined marking rules may define a suitable marking type based on the component property.

in an example, the component sub type—raster image may be associated with an image watermarking technique. Further, the component sub type—vector image may be first converted to a raster image and marked in a similar way as a raster image, using image watermarking technique. Further, in case a vector image is a logo or includes a logo then the vector image may be identified as a non markable component.

In one example, the component sub type—dense text may be identified as no marking region, as inserting an identification mark behind a dense text may affect the readability of the text. Further, for the component sub type—sparse text, binary watermarking may be identified as the marking technique, for inserting identification marks behind the text regions. Further, for the component sub type—white, binary watermarking may be identified as the marking technique, for inserting identification marks in the form of a binary watermark having black dots. Further, for the component sub type—black, binary watermarking may be identified as the marking technique, for inserting identification marks in the form of a binary watermark having white dots.

In one example, for the component sub type—white/black, binary watermarking may be identified as the marking technique for inserting identification marks in the form of a binary watermark in a single ink color with a polarity in a range of 0 to 100%. Further, the polarity of binary watermark may be determined depending on the polarity of the background color, varying between dark or light, in such a way that visual perception is not affected. Further, for the component sub type—colored region, marking technique may be identified from among binary watermarking technique, barcoding, and QR coding. In case of binary watermarking technique, the identification marks may be inserted in the form of transparent watermarked tint images.

The marking technique analyzer 106 may subsequently identify the marking technique determined for the component sub types as the marking technique for linking the identification mark with the corresponding component.

For example, the marking technique analyzer 106 may determine the marking technique for the components 304-1, 304-2, having the component sub type—raster image, as the image watermarking technique. Similarly, the marking technique analyzer 106 may determine the component 304-3, having component sub type—vector image, as a non markable component since the component 304-3 is a logo. Further, the marking technique analyzer 106 may determine the binary watermarking technique as the marking technique for the components 304-4 and 304-6, having the component sub type—sparse text. Similarly, the marking technique analyzer 106 may determine the component 304-5, having component sub type—dense text, as a no marking region.

Further, the marking technique analyzer 106 may determine the binary watermarking technique having black dots as the marking technique for the components 304-7 and 304-8, having component sub type—white. Similarly, the marking technique analyzer 106 may determine the binary watermarking technique having white dots as the marking technique for the component 304-9, having the component sub type—black. The marking technique analyzer 106 may further determine the marking technique for the component 304-10, having the component sub type—colored region, from among binary watermarking technique, barcoding, and QR coding.

Further, the marking technique analyzer 106 may generate the marking settings for each of the plurality of components 304. As previously described, the marking settings for a component may include the marking technique identified for linking an identification mark with the component. In one example, the marking technique analyzer 106 may save the marking settings for the components 304 in the marking technique data 226. Subsequently, the marking technique analyzer 106 may communicate the print artwork and the marking settings to the identification marking engine 206.

In one example, the identification marking engine 206 may use the print artwork, the marking settings, set of user defined identification marks, and user inputs for marking a set of components 304 from the plurality of components 304 with the identification marks. In an example, the set of components 304 may be same as the plurality of components 304. In another example, the set of components 304 may be a smaller group from within the plurality of components 304. For instance, the user may specify certain components that may not be embedded with any identification marks. Further, in one example, the identification marking engine 206 may use the same identification mark for the set of components 304. In another example, the identification marking engine 206 may use different identification marks for different components of the set of components 304. The identification marking engine 206 may subsequently generate a marked-up print artwork.

In one example, the identification marking engine 206 may generate a single copy of the marked-up print artwork. In another example, the identification marking engine 206 may generate a marked-up print artwork file including a plurality of copies of the marked-up print artwork such that each copy of the marked-up print artwork has a unique set of identification markings. For instance, each copy of the marked-up print artwork may have a different identification marking, indicating a serial number of the artwork, for instance, to indicate serialization codes in a packaging industry.

The identification marking engine 206 may subsequently share the marked-up print artwork with the marking technique analyzer 106. On receiving the marked-up print artwork, the marking technique analyzer 106 may generate a print ready artwork using the marked-up print artwork and store the print ready artwork in the marking technique data 228.

In one example, the marking technique analyzer 106 may provide the print ready artwork to the user device 204. The user of the user device 204 may store the print ready artwork in the user device 204 or print the print ready artwork using a print device, such as the print device 210. In another example, the marking technique analyzer 106 may provide the print ready artwork to the print device 210.

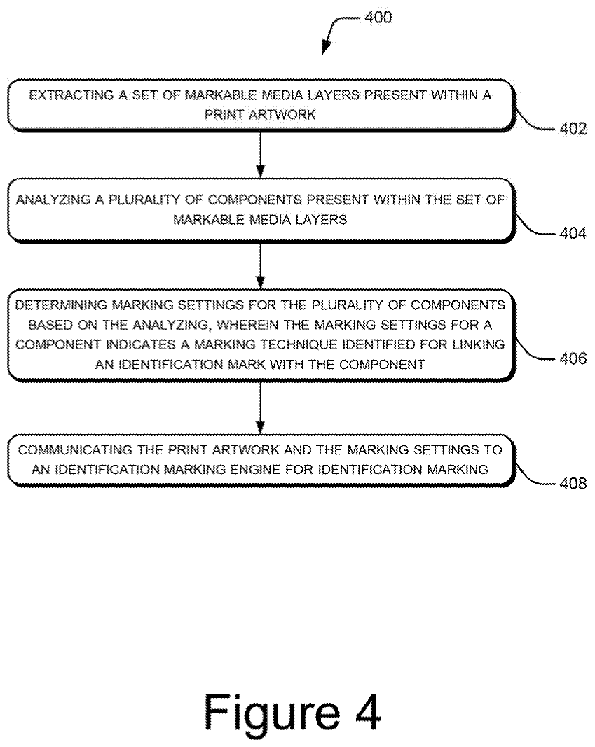

FIG. 4 illustrates the method 400 for marking technique identification, according to an example implementation of the present subject matter. At block 402, a set of markable media layers present within a print artwork is extracted. Examples of the print artwork may include, but are not limited to, a packaging artwork, layout of a book, and an advertising banner. In one example, the print artwork may be provided by a user device, such as the user device 204, to an artwork analyzer, such as the artwork analyzer 208 for marking technique identification. Initially, upon receiving the print artwork, a plurality of media layers present within the print artwork are extracted. Subsequently, the set of markable media layers is extracted, from among the plurality of media layers, based on a hierarchy of each of the plurality of media layers. In one example, the media layers may be extracted using segmentation techniques.

At block 404, a plurality of components present within the set of markable media layers are analyzed. Examples of the components may include, but are not limited to, images, text regions, logos, and white/non-white space. In one example, techniques such as image recognition, optical character recognition, and feature extraction may be used to identify components present in the print artwork.

At block 406, based on the analysis, marking settings for the plurality of components are determined. The marking settings for a component indicates a marking technique identified for linking an identification mark with the component. In one example, the marking settings may be analyzed based on component properties and predefined marking rules. For instance, initially, a component type may be determined for each component based on a component type tag. Further, a component sub type may be determined, for the component, based on the component properties and the component type. Subsequently, the marking technique may be determined for the component sub type based on the predefined marking rules. The determined marking technique may then be identified as the marking technique for linking the identification mark with the component.

At block 408, the print artwork and the marking settings are communicated to an identification marking engine for identification marking. In one example, the identification marking engine 206 may link identification marks with a set of components from the plurality of components. In an example, the set of components may be same as the plurality of components. In another example, the set of components may be a smaller group from within the plurality of components. For instance, the user may specify certain components that may not be embedded with any identification marks. Further, in one example, the identification marking engine 206 may use the same identification mark for the set of components. In another example, the identification marking engine 206 may use different identification marks for different components of the set of components.

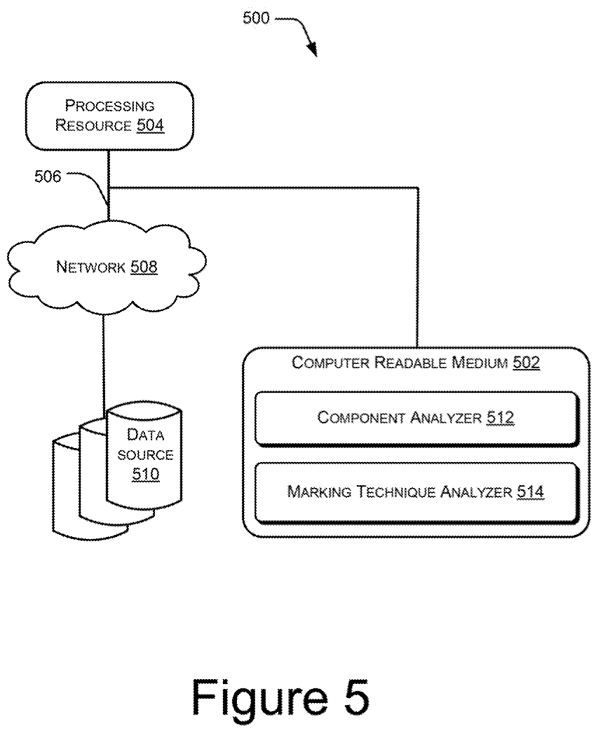

FIG. 5 illustrates an example network environment 500 using a non-transitory computer readable medium 502 for marking technique identification, according to an example implementation of the present subject matter. The network environment 500 may be a public networking environment or a private networking environment. In one example, the network environment 500 includes a processing resource 504 communicatively coupled to the non-transitory computer readable medium 502 through a communication link 506.

For example, the processing resource 504 can be a processor of an electronic device, such as the artwork analyzer 208. The non-transitory computer readable medium 502 can be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 can access the non-transitory computer readable medium 502 through a network 508. The network 508 may be a single network or a combination of multiple networks and may use a variety of communication protocols.

The processing resource 504 and the non-transitory computer readable medium 502 may also be communicatively coupled to data sources 510 over the network 508. The data sources 510 can include, for example, databases and computing devices. The data sources 510 may be used by the database administrators and other users to communicate with the processing resource 504.

In one example, the non-transitory computer readable medium 502 includes a set of computer readable instructions, such as a component analyzer 512, and a marking technique analyzer 514. As would be understood, the component analyzer 512 implements the functionality of the component analyzer 104, and the marking technique analyzer 514 implements the functionality of the marking technique analyzer 106. The set of computer readable instructions, referred to as instructions hereinafter, can be accessed by the processing resource 504 through the communication link 506 and subsequently executed to perform acts for facilitating facsimile communication.

For discussion purposes, the execution of the instructions by the processing resource 504 has been described with reference to various components introduced earlier with reference to the description of FIGS. 1-3.

On execution by the processing resource 504, the component analyzer 512, may identify a plurality of components present within a print artwork, such as a print artwork 302. In one example, the print artwork 302 may include the plurality of media layers layered one above the other. Thus, each of the plurality of media layers may have a defined hierarchy, also to referred as depth, with respect to other media layers. In one example, the hierarchy of a media layer may indicate a number of media layers present above the media layer.

The marking technique analyzer 514 may further determine marking settings for the plurality of components based on component properties and predefined marking rules. In one example, the marking settings for a component indicates a marking technique identified for linking an identification mark with the component. Example of different identification marking technique may include, but are not limited to, barcodes, quick response (QR) codes, and digital watermarks.

The marking technique analyzer 514 further communicates the print artwork and the marking settings to an identification marking engine for identification marking. The identification marking engine links a set of components from the plurality of components with identification marks. In an example, a set of components may be each of the plurality of components. In another example, a set of components may be a selected based on set of components. For instance, the user may specify certain components that may not be embedded with any identification marks.

Although examples for the present subject matter have been described in language specific to structural features and/or methods, it should be understood that the appended claims are not limited to the specific features or methods described. Rather, the specific features and methods are disclosed and explained as examples of the present subject matter.

What is claimed is:

1. An identification marking system comprising:
a component analyzer to identify a plurality of components present within a print artwork; and
a marking technique analyzer to:
determine marking settings for the plurality of components based on component properties and predefined marking rules, wherein the marking settings for a component indicates a marking technique identified for linking an identification mark with the component; and
communicate the print artwork and the marking settings to an identification marking engine for identification marking.

2. The identification marking system as claimed in claim 1, wherein the component analyzer further is to:
analyze the print artwork to extract a plurality of media layers present within the print artwork;
identify a set of markable layers, from among the plurality of media layers, based on a hierarchy of each of the plurality of media layers; and
identify, for each of the markable layers, components present in the markable layer.

3. The identification marking system as claimed in claim 1, wherein the component analyzer further is to:
tag each component, from the plurality of components, with a component type tag, wherein the component type tag is selected from a group consisting of images, text, spot color, non markable components, and, no ink areas; and
analyze each component to determine the component properties of the component.

4. The identification marking system as claimed in claim 3, wherein the marking technique analyzer further is to:
determine a component type for each component, based on the component type tag;
determine, for the component, a component sub type based on the component properties and the component type;
determine the marking technique for the component sub type based on the predefined marking rules; and
identify the determined marking technique as the marking technique for linking the identification mark with the component.

5. The identification marking system as claimed in claim 1, wherein the marking technique analyzer further is to:
receive a marked-up print artwork having identification markings linked with a set of components, from among the plurality of components; and
generate a print ready artwork using the marked-up print artwork;
provide the print ready artwork to a print device for printing.

6. A method for marking technique identification, the method comprising:
extracting a set of markable media layers present within a print artwork;
analyzing a plurality of components present within the set of markable media layers;
determining marking settings for the plurality of components based on the analyzing, wherein the marking settings for a component indicates a marking technique identified for linking an identification mark with the component; and
communicating the print artwork and the marking settings to an identification marking engine for identification marking.

7. The method as claimed in claim 6, wherein the extracting comprises:
analyzing the print artwork to extract a plurality of media layers present within the print artwork;
determining a hierarchy of each of the plurality of media layers, wherein the hierarchy of a media layer indicates a number of other media layers above the media layer; and
identifying media layers underneath an opaque media layer as non-markable layers and classifying remaining media layers as the set of markable layers.

8. The method as claimed in claim 6, wherein the analyzing the plurality of components comprises:
identifying, for each of the markable layers, components present in the markable layer;
tagging each component, from the plurality of components, with a component type tag, wherein the component type tag is selected from a group consisting of images, text, spot color, non markable components, and, no ink areas; and
determining component properties of each component.

9. The method as claimed in claim 8, wherein the determining the marking settings comprises:
identifying the marking technique for each component based on the component type tag, the component properties, and predefined marking rules;
for each component, generate marking settings comprising the marking technique and the component properties corresponding to the component.

10. The method as claimed in claim 9, wherein the identifying the marking technique for each component comprises:
determining, for the component, a component type based on the component type tag;
determining, for the component, a component sub type based on the component properties and the component type;
determining the marking technique for the component sub type based on the predefined marking rules; and
identifying the determined marking technique as the marking technique for linking the identification mark with the component.

11. A non-transitory computer readable medium having a set of computer readable instructions that, when executed, cause a processor to:
identify a plurality of components present within a print artwork;
determine marking settings for the plurality of components based on component properties and predefined marking rules, wherein the marking settings for a component indicates a marking technique identified for linking an identification mark with the component; and
communicate the print artwork and the marking settings to an identification marking engine for identification marking.

12. The computer readable medium as claimed in claim 11, wherein the computer readable instructions, when executed, further cause the processor to:
analyze the print artwork to extract a plurality of media layers present within the print artwork;
identify a set of markable layers, from among the plurality of media layers, based on a hierarchy of each of the plurality of media layers; and
identify, for each of the markable layers, components present in the markable layer.

13. The computer readable medium as claimed in claim 11, wherein the computer readable instructions, when executed, further cause the processor to:
identify, for each of the markable layers, components present in the markable layer;
tag each component, from the plurality of components, with a component type tag, wherein the component type tag is selected from a group consisting of images, text, spot color, non markable components, and, no ink areas; and
determine the component properties of each component.

14. The computer readable medium as claimed in claim 13, wherein the computer readable instructions, when executed, further cause the processor to:
for each component, determine a component type based on the component type tag;
determine, for the component, a component sub type based on the component properties and the component type;
determine the marking technique for the component sub type based on the predefined marking rules;
identify the determined marking technique as the marking technique for linking the identification mark with the component; and
for each component, generate marking settings comprising the marking technique.

15. The computer readable medium as claimed in claim 11, wherein the computer readable instructions, when executed, further cause the processor to:
receive a marked-up print artwork file having identification markings linked with a set of components, from among the plurality of components, wherein marked-up print artwork file includes a plurality of copies of the marked-up print artwork, wherein each copy of the marked-up print artwork has a unique set of identification markings;
generate a print ready artwork using the marked-up print artwork file; and
provide the print ready artwork to a print device for printing.
